(19) United States
(12) Patent Application Publication
(10) Pub. No.: US 2025/0073794 A1
(43) Pub. Date: Mar. 6, 2025

(54) BAND SAW

(71) Applicant: MILWAUKEE ELECTRIC TOOL CORPORATION, Brookfield, WI (US)

(72) Inventors: Wesley S. Bassindale, Wauwatosa, WI (US); Terry L. Timmons, Jr., Oconomowoc, WI (US); Arber Halimi, Hartland, WI (US); William B. Howarth, Milwaukee, WI (US)

(21) Appl. No.: 18/820,621

(22) Filed: Aug. 30, 2024

Related U.S. Application Data
(60) Provisional application No. 63/535,598, filed on Aug. 31, 2023.

(51) Int. Cl. B23D 53/12; B23D 55/02; B23D 55/06

(52) U.S. Cl. CPC B23D 53/12; B23D 55/02; B23D 55/065

(57) ABSTRACT

A band saw including a housing defining a longitudinal axis, a motor, a battery pack removably coupled to a central portion of the housing, a drive wheel assembly positioned within a deck portion of the housing, an opening defined within the deck portion, an endless saw blade, and a rear handle having a curvilinear shape with a first handle end coupled to the central portion and a second handle end adjacent to the deck portion. The rear handle defines a curved path extending between a first end point at the first handle end and a second end point at the second handle end. A first tangent line is tangent to the curved path at the first end point and extends parallel to the longitudinal axis. A second tangent line is tangent to the curved path at the second end point and extends perpendicular to the longitudinal axis.

### CROSS-REFERENCE TO RELATED APPLICATIONS

This application claims priority to U.S. Provisional Patent Application No. 63/535,598 filed on Aug. 31, 2023, the entire content of which is incorporated herein by reference.

### FIELD OF THE INVENTION

The present invention relates to power tools, and more specifically to band saws.

### BACKGROUND OF THE INVENTION

Handheld band saws are used to cut a variety of workpieces, such as pipes, rods, studs, and blocks. A cordless, compact band saw allows for cutting operations in tight spaces or awkward angles for plumbing, electrical, remodeling, and HVAC applications.

### SUMMARY OF THE INVENTION

The present invention provides, in one aspect, a band saw including a housing defining a longitudinal axis extending therethrough in a horizontal direction, a motor supported by the housing, a battery pack removably coupled to a central portion of the housing, and a drive wheel assembly positioned within a deck portion of the housing and rotationally driven by the motor. The drive wheel assembly has a drive wheel and a driven wheel. The band saw further includes an opening defined within the deck portion of the housing and located between the drive wheel and the driven wheel, and below the central portion of the housing. Moreover, the band saw includes an endless saw blade driven by the drive wheel assembly and configured to pass through the opening to cut a workpiece during a cutting operation. In addition, the band saw includes a rear handle having a curvilinear shape with a first handle end coupled to the central portion of the housing and a second handle end adjacent the deck portion of the housing. The rear handle defines a curved path extending between a first end point at the first handle end and a second end point at the second handle end. A first tangent line is tangent to the curved path at the first end point and extends parallel to the longitudinal axis. A second tangent line is tangent to the curved path at the second end point and extends perpendicular to the longitudinal axis.

The present invention provides, in another aspect, a band saw including a housing defining a longitudinal axis extending therethrough in a horizontal direction, a motor supported by the housing, a battery pack removably coupled to a central portion of the housing, a drive wheel assembly positioned within a deck portion of the housing and rotationally driven by the motor. The drive wheel assembly includes a drive wheel and a driven wheel. The band saw further includes an opening defined within the deck portion of the housing and located between the drive wheel and the driven wheel. Moreover, the band saw includes an endless saw blade driven by the drive wheel assembly and configured to pass through the opening to cut a workpiece during a cutting operation. In addition, the band saw includes a front handle coupled to the central portion of the housing and a rear handle. The rear handle has a curvilinear shape with a first handle end coupled to the central portion of the housing and a second handle end adjacent the deck portion of the housing. The rear handle defines a curved path extending between a first end point at the first handle end and a second end point at the second handle end. a first plane intersects the first end point and a second plane intersects the second end point. The first plane and the second plane are parallel to each other and extend perpendicular to the longitudinal axis. The motor is located between the first plane and the second plane. The battery pack is located between the front handle and the first plane.

The present invention provides, in another aspect, a band saw including a housing, a motor supported by the housing, and a drive wheel assembly rotationally driven by the motor. The drive wheel assembly has a drive wheel and a driven wheel. The band saw further includes an opening defined within the housing and located between the drive wheel and the driven wheel. Moreover, the band saw includes an endless saw blade driven by the drive wheel assembly and configured to pass through the opening to cut a workpiece during a cutting operation, a rear handle coupled to the housing and defining a curvilinear shape having a first arc length, and a trigger disposed on the rear handle and configured to actuate the motor. The trigger having a curvilinear shape defining a second arc length. The second arc length is at least 20 percent of the first arc length.

The present invention provides, in another aspect, a band saw including a housing, a motor supported by the housing, and a drive wheel assembly rotationally driven by the motor. The drive wheel assembly has a drive wheel and a driven wheel. The band saw further includes an opening defined within the housing and located between the drive wheel and the driven wheel. Moreover, the band saw includes an endless saw blade driven by the drive wheel assembly and configured to pass through the opening to cut a workpiece during a cutting operation. The opening defines a cut zone located above the endless saw blade. In addition, the band saw includes a material guiding mechanism having a material guide movably coupled to the housing and configured to receive the workpiece. The material guide has a slot defined therein and configured to receive the endless saw blade. The material guide is movable from a first position located outside the cut zone to a second position located within the cut zone during the cutting operation.

The present invention provides, in another aspect, a band saw including a housing having a handle configured to be grasped by a user during a cutting operation, a motor supported by the housing, and a drive wheel assembly rotationally driven by the motor. The drive wheel assembly includes a drive wheel and a driven wheel. The band saw further includes an opening defined within the housing and located between the drive wheel and the driven wheel, an endless saw blade driven by the drive wheel assembly and configured to pass through the opening to cut a workpiece during the cutting operation, and a level coupled to the housing.

### BRIEF DESCRIPTION OF DRAWINGS

FIG. 1 is a front perspective view of a band saw according to an embodiment of the present invention.

FIG. 2 is a rear perspective view of the band saw of FIG. 1.

FIG. 3 is a rear perspective view of the band saw of FIG. 1 including an attached blade cover.

FIG. 4 is cross-sectional view of the band saw of FIG. 1 through section line 4-4 in FIG. 3.

FIG. 5 is a front view of a level assembly for the band saw of FIG. 1.

FIG. 6A is an enlarged view of the band saw of FIG. 1, the band saw including a level.

FIG. 6B is an enlarged view of the band saw of FIG. 1, the band saw including the level assembly of FIG. 5.

FIG. 7 is a front view of the band saw of FIG. 1.

FIG. 8 is an enlarged front view of a portion of the band saw of FIG. 1.

FIG. 9 is an enlarged rear perspective view of a rear handle of the band saw of FIG. 1.

FIG. 10A is a front perspective view of a band saw according to another embodiment of the present invention, the band saw including a material guiding mechanism in a first position.

FIG. 10B is a front perspective view of the band saw of FIG. 10A, the material guiding mechanism in a second position.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

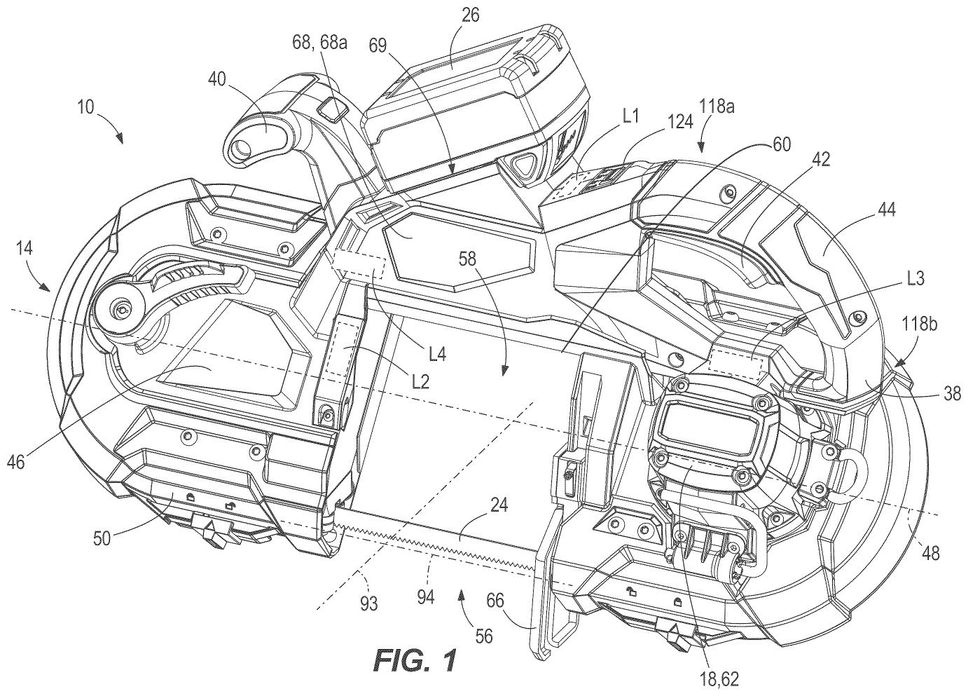

FIGS. 1-4 illustrate a band saw 10 including a frame or housing 14 supporting a drive mechanism including a motor 18 and a transmission 20. In the illustrated construction of the band saw 10, the motor 18 is configured as a brushless DC (BLDC) electric motor, and the band saw 10 includes a removable, rechargeable battery pack 26 (FIG. 1) for supplying electrical current to the motor 18. The drive mechanism further includes a drive wheel assembly 30, which is driven by the motor 18 via the transmission 20. The motor 18, the transmission 20, and the drive wheel assembly 30 are supported by the housing 14. The transmission 20 may include different gear train arrangements (e.g., a single or multi-stage planetary gear train) configured to provide a low-speed, high-torque output from the high-speed, low-torque input of the motor 18. The drive mechanism is operable to drive an endless band saw blade 24 to cut a workpiece.

With continued reference to FIGS. 1-4, the housing 14 includes a first handle or a rear handle 38 and a second handle or a front handle 40 disposed opposite the rear handle 38. The rear handle 38 is provided with a trigger 42 to selectively activate the electric motor 18. The trigger 42 is disposed along a gripping portion 44 of the rear handle 38 where a user grasps the band saw 10. In the illustrated construction of the band saw 10, the battery pack 26 is supported by the housing 14 between the rear handle 38 and the front handle 40. The trigger 42 is operable to control operation of the motor 18. Specifically, the battery pack 26 selectively supplies electrical current to the motor 18 when the trigger 42 is depressed.

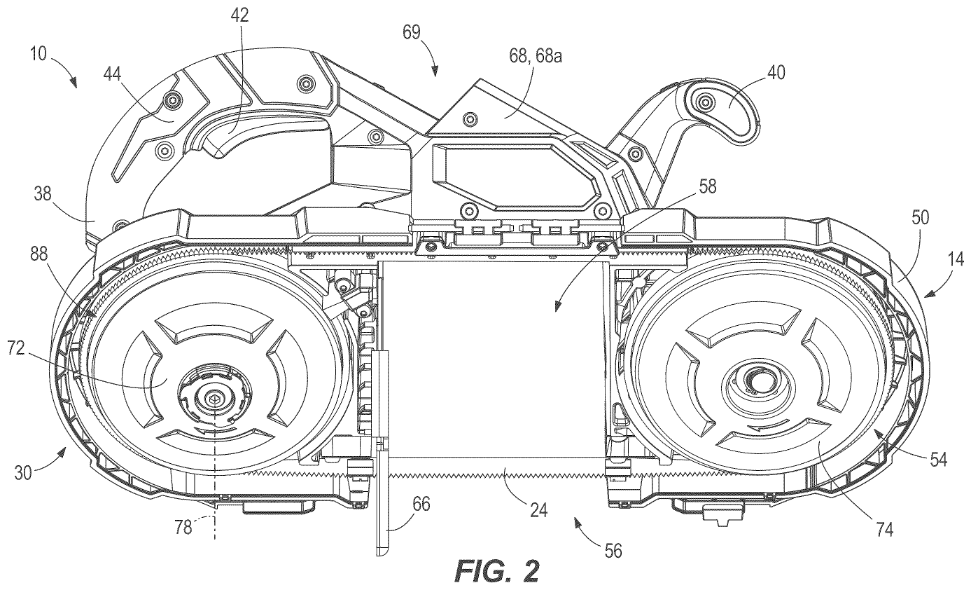

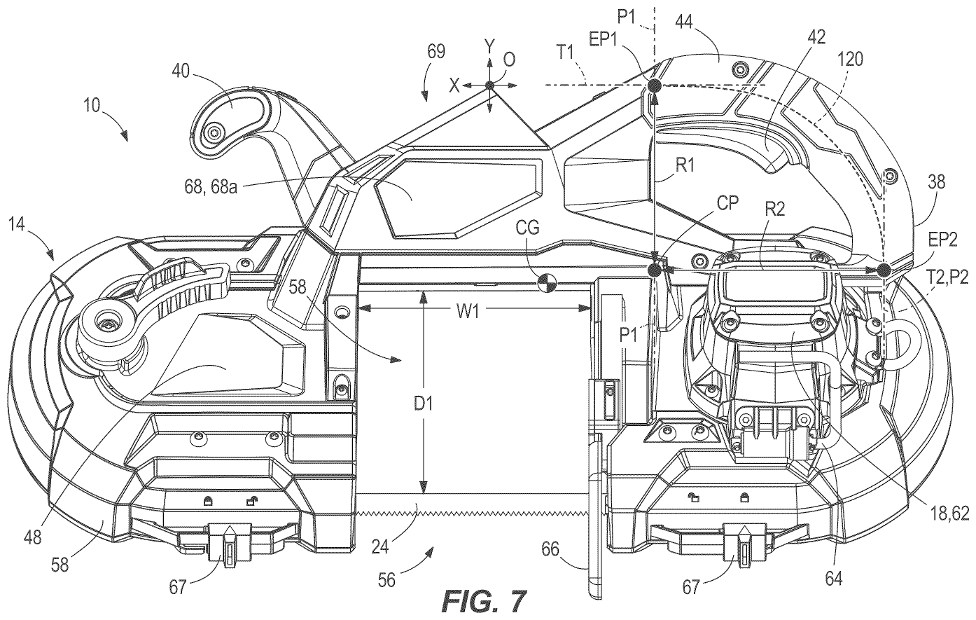

The housing 14 of the band saw 10 also includes a deck portion 46 and a guard 50 coupled to the deck portion 46, and thereby define a longitudinal axis 48 of the housing 14 extending therethrough in a horizontal direction. The deck portion 46 and the guard 50 form a cavity 54 (FIG. 2) in which the drive wheel assembly 30 and the band saw blade 24 are at least partially positioned. The deck portion 46 defines an opening 56 and a cut zone 58. The opening 56 is defined as the entire gap within the deck portion 46, including the space in which the saw blade 24 travels through. The cut zone 58 is defined as the space extending between the saw blade 24 and a top edge 60 (FIG. 1) of the deck portion 46. The cut zone 58 has a width W1 (FIG. 7) of about 5 inches and a depth D1 (FIG. 7) of about 5 inches. As such, the cut zone 58 is structured as a large cut zone configured to receive and fit a large workpiece (e.g., a workpiece with a large diameter). The deck portion 46 and the guard 50 substantially cover the band saw blade 24 when the blade 24 is in a shielded position (i.e., when the blade 24 is not within the cut zone 58). However, the deck portion 46 and the guard 50 do not cover the band saw blade 24 when the blade 24 is in an exposed position (i.e., when the blade 24 passes through the cut zone 58). In the exposed position, the blade 24 is fully exposed and unobstructed by the guard 50, allowing workpieces to be cut when entering the cut zone 58. The deck portion 46 includes a motor housing portion 62 that encloses the motor 18 and, if used, the transmission 20. In addition, a hook 64 (FIG. 7) is coupled to the deck portion 46 and disposed below the motor housing portion 62. A user may hang the band saw 10 from a workpiece by using the hook 64.

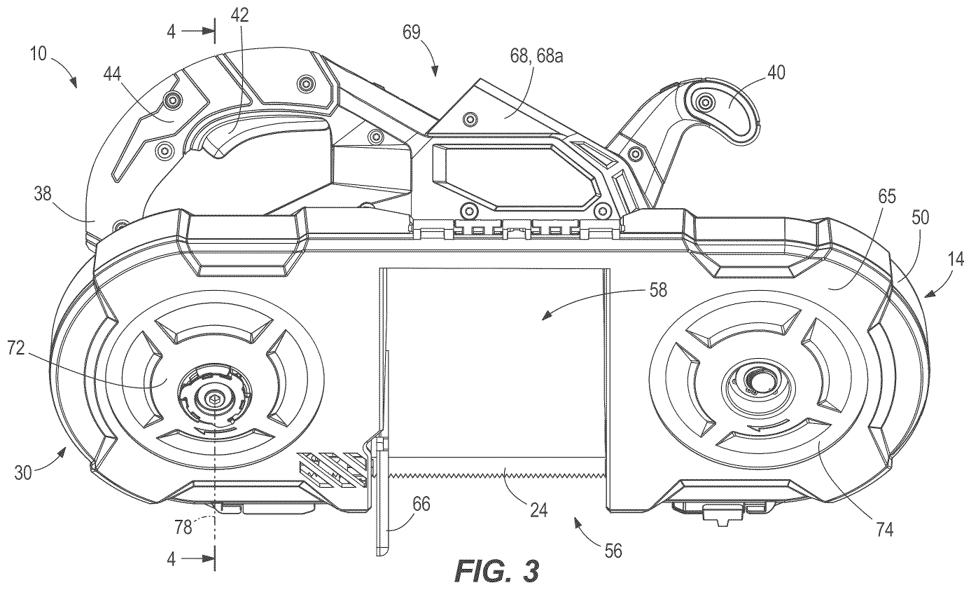

The band saw 10 further includes a blade cover 65 (FIG. 3) removably coupled to the guard 50 and a shoe 66 coupled to the housing 14. The shoe 66 has a support surface configured to abut a work piece during a cutting operation. Two latches 67 (FIG. 7) are provided on the guard 50 to interconnect the blade cover 65 with the guard 50 of the housing 14. The latches 67 are slidable between a first position, in which the blade cover 65 and the guard 50 are coupled, and a second position, in which the blade cover 65 and the guard 50 are uncoupled. When the blade cover 65 is coupled to the guard 50, the blade cover 65 is arranged to cover a bottom portion of the saw blade 24 that is traveling along the drive wheel assembly 30. In other embodiments, the blade cover 65 is integrally formed with the guard 50.

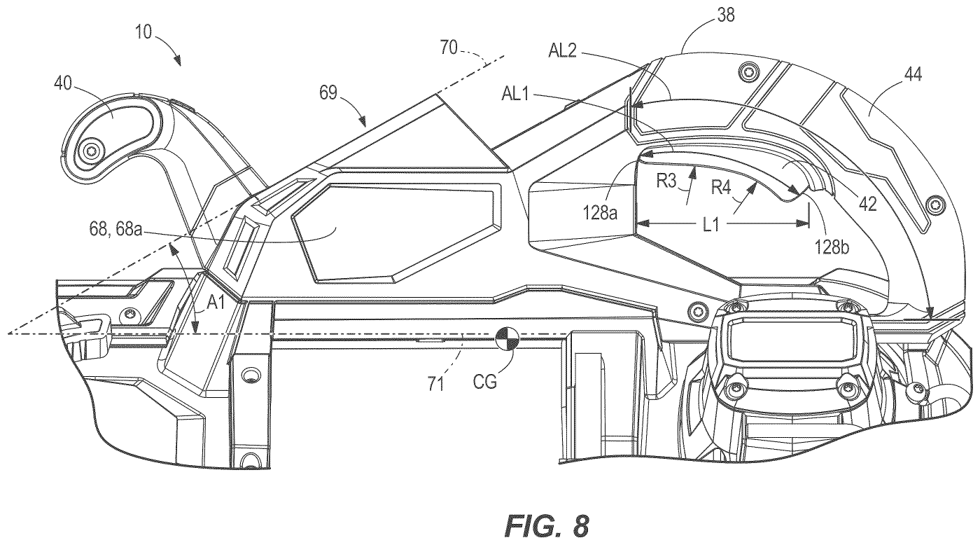

With reference to FIGS. 1 and 8, the housing 14 of the band saw 10 includes an electronics housing portion 68 disposed above the cut zone 58. In the illustrated embodiment, a central portion 68a of housing 14 is the electronics housing portion 68. The electronics housing portion 68 is also coupled to and disposed between the rear handle 38 and the front handle 40. Electronic components (e.g., a power and/or control printed circuit board; not shown) used to operate the band saw 10 are housed within the electronics housing portion 68. A battery receptacle 69 is formed on the electronics housing portion 68 and configured to receive the battery pack 26. As such, the electronic components within the electronics housing portion 68 electrically connect the battery pack 26 to the motor 18. The battery receptacle 69 is arranged on the band saw 10 such that the battery pack 26 is disposed between the rear handle 38 and the front handle 40, when coupled to the battery receptacle 69. More specifically, the battery pack 26 is arranged forward of the motor 18 and the rear handle 38.

The battery pack 26 is attachable to the battery receptacle 69 along a battery insertion axis 70 (FIG. 8) that is oriented at an insertion angle Al relative to a reference axis 71 extending parallel to the longitudinal axis 48. In other words, the battery insertion axis 70 is obliquely oriented relative to the longitudinal axis 48. The insertion angle A1 ranges between 0 degrees and 60 degrees, and preferably is 30 degrees. In other embodiments, the insertion angle Al may be 45 degrees. For removal of the battery pack 26 from the battery receptacle 69, one hand of the user may grasp the rear handle 38. The other hand of the user pulls the battery pack 26 in a rearward direction of the band saw 10 and along the battery insertion axis 70 to detach the battery pack 26 from the battery receptacle 69.

With reference to FIG. 7, the band saw 10 is illustrated with an origin O positioned at the top of the battery receptacle 69. The origin O defines a coordinate system including an X-axis extending parallel to the longitudinal axis 48 and a Y-axis extending perpendicular to the longitudinal axis 48. When the battery pack 26 is attached to the battery receptacle 69, the band saw 10 has a center of gravity CG positioned along the deck portion 46 and adjacent the opening 56. More specifically, the center of gravity CG is positioned 100 mm below the origin O along the Y-axis and 25 mm rearward (i.e., toward the motor 18) along the X-axis. Also, the center of gravity CG is located between the rear handle 38 and the front handle 40. When the battery pack 26 is not attached to the battery receptacle 69, the weight of the band saw 10 ranges between 10 pounds and 12 pounds. As such, the band saw 10 is constructed as a portable lightweight band saw with a large cut zone 58.

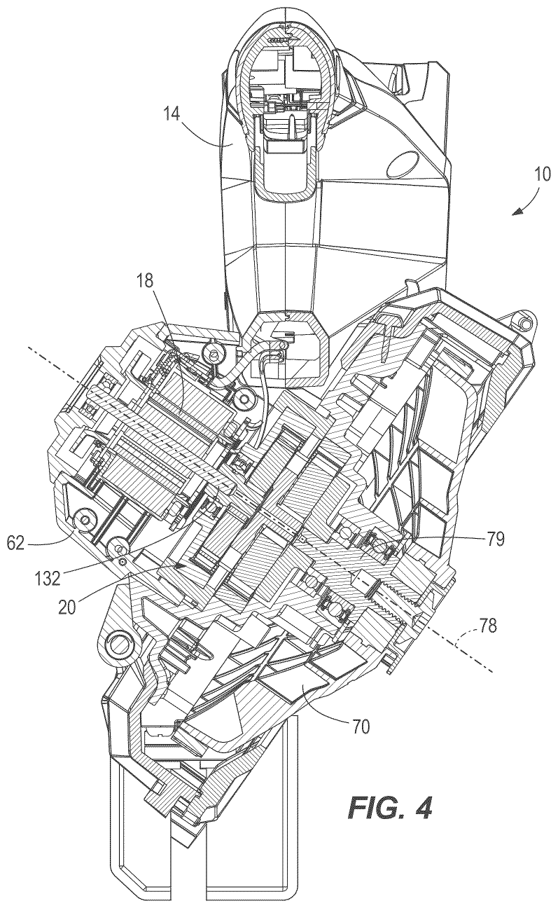

With reference back to FIG. 2, the drive wheel assembly 30 includes a drive wheel 72 that is driven by the motor 18 and a driven wheel 74 that is driven by the drive wheel 72 via the saw blade 24. Portions of the drive wheel 72 and the driven wheel 74 are covered by the deck portion 46 and the guard 50. The drive wheel 72 rotates about a drive wheel axis 78 defined by a drive wheel spindle 79 (FIG. 4) that is coupled to and driven by the transmission 20 (FIG. 4). The drive wheel spindle 79 is keyed to the drive wheel 72, such that the drive wheel spindle 79 and the drive wheel 72 co-rotate. The drive wheel 72 is drivingly connected to the motor 18 via the transmission 20 and the drive wheel spindle 79. A tire 88 is coupled to the outer peripheral surface of each of the wheels 72, 74 (although only one of which is shown in FIG. 2). Each tire 88 grips the saw blade 24 to drive motion thereof.

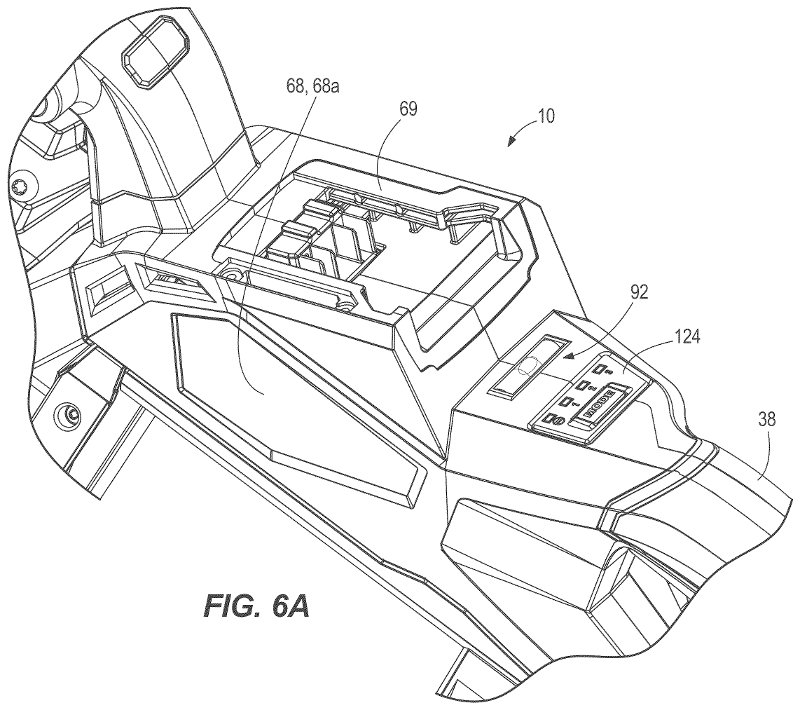

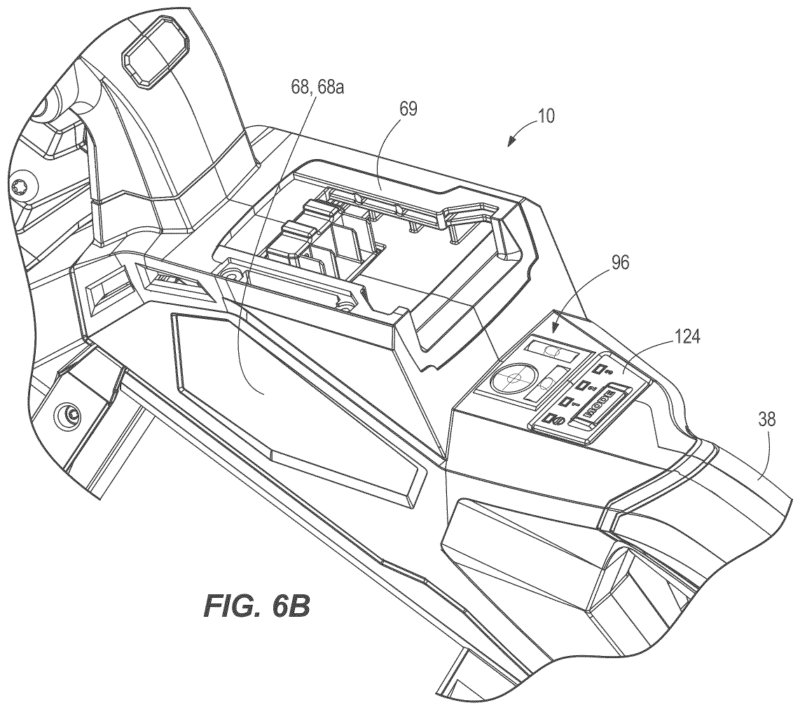

With reference back to FIGS. 1 and 6A, the band saw 10 further includes a spirit or bubble level 92 coupled to the housing 14 to indicate alignment and/or inclination of the band saw 10 relative to a workpiece prior to and during a cutting operation. For example, the level 92 may indicate the inclination of the band saw 10, and more specifically the saw blade 24, to the user about a first pivot axis 93 (FIG. 1) oriented perpendicular to the span of the saw blade 24 through the cut zone 58 and a second pivot axis 94 (FIG. 1) oriented parallel to the span of the saw blade 24 through the cut zone 58. In the illustrated embodiment, the level 92 is disposed at a first location L1 (FIG. 1). The first location L1 is specifically located on the electronics housing portion 68 and disposed between the rear handle 38 and the battery receptacle 69.

The level 92 can also be disposed on the deck portion 46 adjacent the cut zone 58 at a second location L2. Specifically, the second location L2 is located on a surface of the deck portion 46 extending from the electronics housing portion 68 and spaced from the motor 18. In addition, the level 92 can be disposed on the housing 14 adjacent the motor 18 at a third location L3. In the illustrated embodiment, the third location L3 is located above the motor 18. In other embodiments, the third location L3 can be located below the motor 18. Moreover, the level 92 can be disposed on the electronics housing portion 68 at a fourth location L4. The fourth location L4 is adjacent the front handle 40, as shown in the illustrated embodiment. In some embodiments, the fourth location L4 can be located on the electronics housing portion 68 adjacent the rear handle 38. In other embodiments, the fourth location L4 can be centrally located on the electronics housing portion 68.

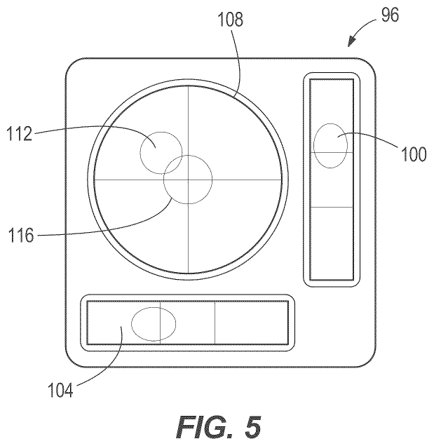

With reference to FIGS. 5 and 6B, a spirit or bubble level assembly 96 is illustrated. The level assembly 96 can be coupled to the housing 14 of the band saw 10 in place of the single level 92 of FIG. 6A. The level assembly 96 includes a first level 100, a second level 104, and a bull's eye level or a circular level 108. In an embodiment of the band saw 10 in which the level 92 is replaced with the level assembly 96, the first level 100 indicates the inclination of the band saw 10 about the first pivot axis 93 and the second level 104 indicates the inclination of the band saw 10 about the second pivot axis 94. For example, an inclination of 0 degrees about the first pivot axis 93 (with the bubble located in the center of the first level 100) indicates that the band saw 10 is oriented horizontally (relative to ground) above the workpiece. And, an inclination of 0 degrees about the second pivot axis 94 (with the bubble located in the center of the second level 104) indicates that the band saw 10 is oriented vertically (relative to ground) above the workpiece.

The circular level 108 combines the visual output of the levels 100, 104 to indicate the overall inclination of the band saw 10 relative to the workpiece about the first pivot axis 93 and second pivot axis 94. As such, the level assembly 96 allows a user to determine inclination of the band saw 10 in two directions (about both the first pivot axis 93 and the second pivot axis 94). When a bubble 112 within the circular level 108 aligns with the center of a crosshairs 116 of the circular level 108, then the band saw 10 is oriented horizontally (relative to ground) and vertically (relative to ground) above the workpiece.

With reference to FIG. 7, the rear handle 38 has a curvilinear shape and defines a curved path 120. Also, the rear handle 38 has a first handle end 118a (FIG. 1) coupled to the central portion 68a of the housing 14 and a second handle end 118b (FIG. 1) adjacent the deck portion 46. The curved path 120 extends between a first end point EP1 and a second end point EP2. The first end point EP1 is located at an end of the rear handle 38 that is adjacent the electronics housing portion 68. The second end point EP2 is located at another, opposite end of the rear handle 38 that is adjacent the deck portion 46. A first tangent line T1 is defined tangent to the curved path 120 at first end point EP1 and a second tangent line T2 is defined tangent to the curved path 120 at second end point EP2. The first tangent line T1 extends through the first end point EP1 and is oriented parallel to the longitudinal axis 48. The second tangent line T2 extends through the second end point EP2 and is oriented perpendicular to the longitudinal axis 48. Also, a first plane P1 is oriented to intersect the first end point EP1 and a second plane P2 is oriented to intersect the second end point EP2. The first and second planes P1, P2 are parallel to each other and extend perpendicular to the longitudinal axis 48. As such, the first and second planes P1, P2 are arranged such that the motor 18 is located therebetween. Also, the battery pack 26 is located between the front handle 40 and the first plane P1.

The curved path 120 of the rear handle 38 is defined by a progressively increasing radius from a first radius R1 to a larger, second radius R2. The first radius RI vertically extends between the first end point EP1 and a center point CP of the curved path 120. The second radius R2 horizontally extends between the second end point EP2 and the center point CP. In the illustrated embodiment, the first radius R1 is less than the second radius R2. In other embodiments, the first radius R1 is substantially equal to the second radius R2.

With reference to FIGS. 7-9, the trigger 42 is arranged on the rear handle 38 and configured to be depressed by the user to actuate the band saw 10. In the illustrated embodiment, the trigger 42 is a variable speed trigger configured to change an operating speed of the band saw 10 based on an amount in which the trigger 42 is pulled. The trigger 42 is a part of a trigger switch assembly that also includes a trigger switch (not shown) disposed within the rear handle 38. The trigger 42 is configured to actuate the trigger switch, when depressed by the user. The trigger switch then outputs a variable output signal to operate the motor 18 at a variable rotational speed. In addition, the trigger 42 can also be other types of triggers such as non-contact triggers (e.g., a capacitive trigger). A capacitive touch sensor (not shown) is arranged within the front handle 40 and configured to cooperate with the trigger 42 for the actuation of the band saw 10. As such, the band saw 10 is configured to actuate when the capacitive touch sensor detects the user's hand on the front handle 40 and the trigger 42 is depressed. In other embodiments, the band saw 10 is not provided with a capacitive touch sensor and is only actuated by the trigger 42.

With reference to FIGS. 6A and 6B, the band saw 10 also includes a speed display 124 and a speed control system (not shown). The speed display 124 is arranged on the electronics housing portion 68 at a location between the rear handle 38 and the battery receptacle 69. In some embodiments, the speed display 124 may be arranged on the housing 14 at a location below the rear handle 38. In other embodiments, the speed display 124 may be arranged on the electronics housing portion 68 at a location proximate the trigger 42. The speed display 124 is operable by the user to set the band saw 10 in different operation modes (e.g., speed modes defined by different speed values). The speed control system is independent of the trigger 42 and configured to set a maximum operating speed at which the band saw 10 is operated.

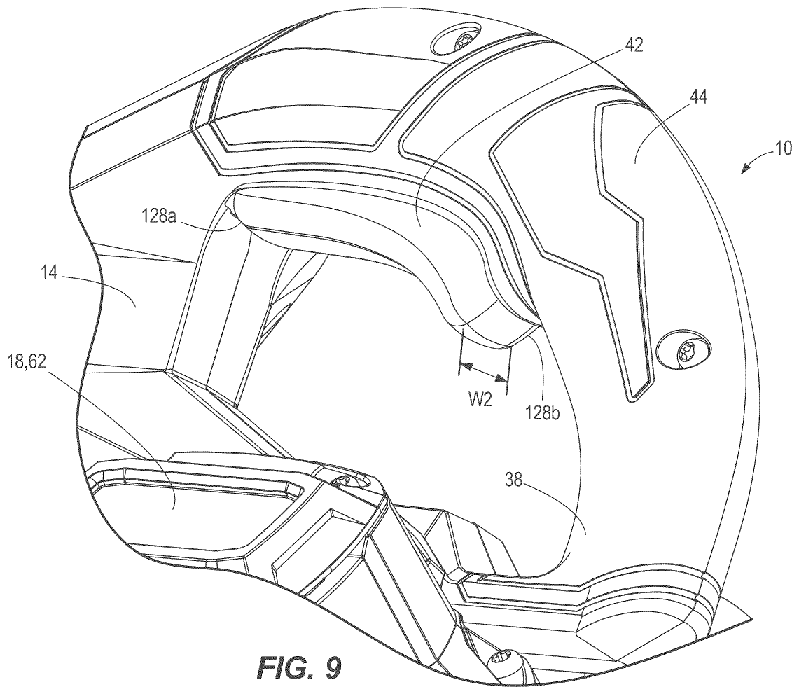

A length L1 (FIG. 8) of the trigger 42 is defined between first and second ends 128a, 128b of the trigger 42. The length L1 of the trigger 42 ranges between 96 mm and 98 mm, and is preferably 97 mm. The trigger 42 also defines a width W2 (FIG. 9) that ranges between 19 mm and 21 mm, and is preferably 20 mm. The trigger 42 has a curvilinear shape and defines a first arc length AL1, while the rear handle 38 defines a second arc length AL2. In some embodiments, the first arc length AL1 is at least 20% of the second arc length AL2. In other embodiments, the first arc length AL1 is at least 30% of the second arc length AL2. In additional embodiments, the first arc length AL1 is at least 40% of the second arc length AL2. The trigger 42 is also defined such that the curvilinear shape defines a third radius R3 and a fourth radius R4 different than the third radius R3. The third radius R3 and the fourth radius R4 are located between the first and second ends 128a, 128b of the trigger 42. The third radius R3 is 55 mm and the fourth radius R4 is 95 mm. As such, the length L1 and the curvilinear shape of the trigger 42 provides the band saw 10 with a long, ergonomically designed trigger 42 that may be easily grasped by the user when operating the band saw 10.

In operation, the user grasps the rear handle 38 and the front handle 40. The user depresses the trigger 42 to actuate the motor 18. The motor 18 outputs a torque through an output shaft 132 of the motor 18 (FIG. 4), in which the torque is transferred to the drive wheel 72 via the transmission 20 and the drive wheel spindle 79. The drive wheel 72 is driven to rotate, causing the saw blade 24 to rotate and in turn, rotate the driven wheel 74. As the saw blade 24 passes through the cut zone 58, the user is allowed to complete a cutting operation.

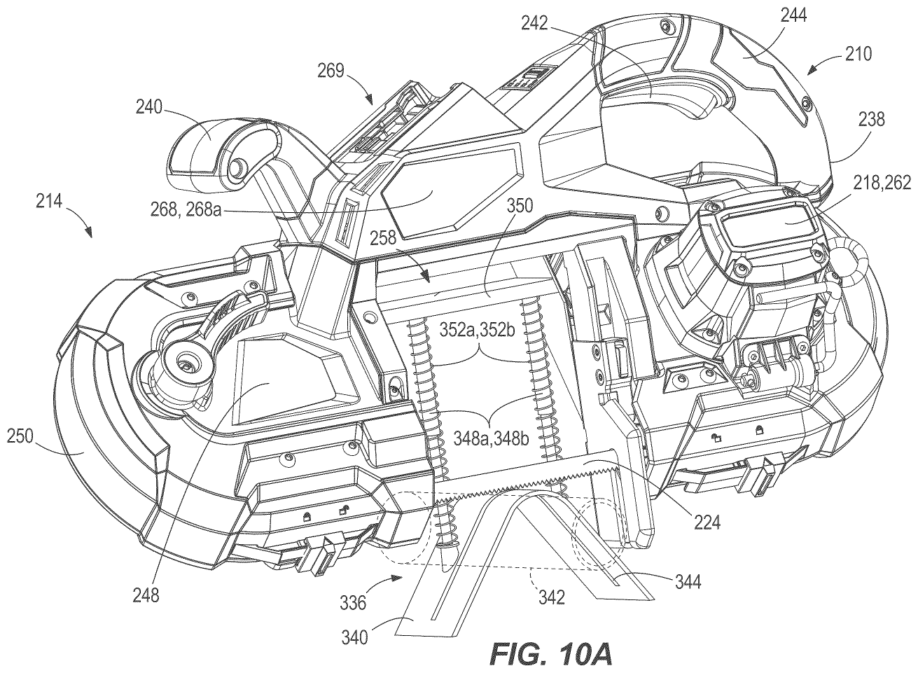

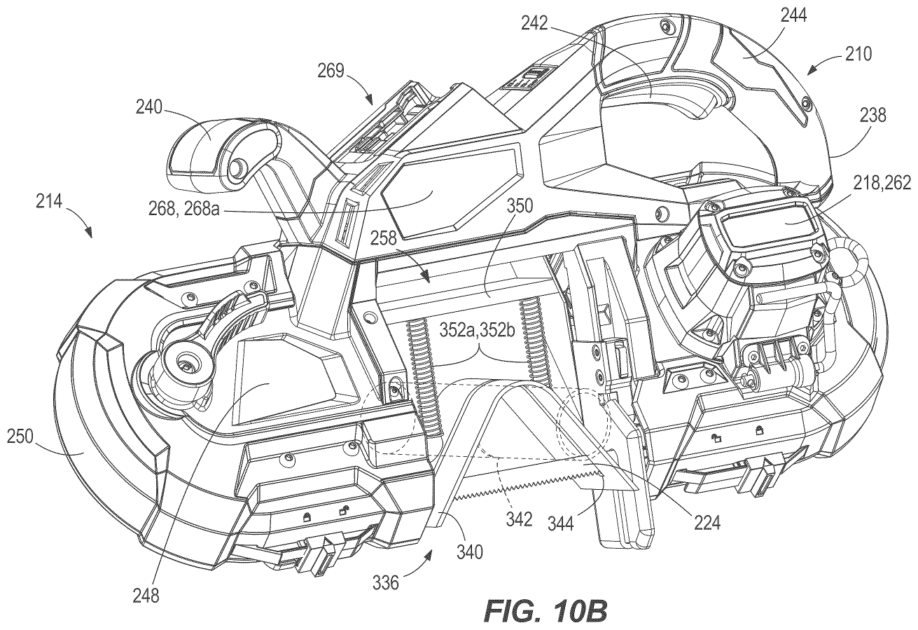

FIGS. 10A and 10B illustrate another band saw 210. The band saw 200 is similar to the band saw 10 of FIGS. 1-8; therefore, like structure will be identified by like reference number plus “200” and only the differences will be discussed hereafter.

The band saw 210 includes a material guiding mechanism 336 coupled to the deck 248 of the housing 214. The material guiding mechanism 336 includes a material guide 340 configured to receive and fit around a workpiece 342 (e.g., a pipe). In the illustrated embodiment, the material guide 340 has a U-shape. A blade slot 344 is also defined within the material guide 340 and configured to receive the saw blade 224. The material guiding mechanism 336 further includes a first telescoping rod 348a and a second telescoping rod 348b coupled at one end to the deck 248 via a support bar 350 of the housing 214. Opposite ends of the first and second telescoping rods 348a, 348b are coupled to the material guide 340 to permit movement of the material guide 340 relative to the housing 214. Each rod 348a, 348b is surrounded by a spring 352a, 352b to bias the material guide 340 in a direction away from the saw blade 224 and housing 214, thereby biasing the telescoping rods 348a, 328b to extended positions. As such, the material guide 340 is movable, with respect to the housing 214, from a first position or an extended position (FIG. 10A) to a second position or a retracted position (FIG. 10B). As the user begins operation of the band saw 210, the material guide 340 is in the extended position and located outside of the cut zone 258. Once the band saw 10 plunges into the workpiece 342 during a cutting operation, the material guide 340 moves relative to the housing 214 and into the cut zone 258 such that the saw blade 224 is received within the blade slot 344.

Although the disclosure has been described in detail with reference to certain preferred embodiments, variations and modifications exist within the scope and spirit of one or more independent aspects of the disclosure as described.

Various features of the present invention are set forth in the following claims.

1. A band saw comprising:
a housing defining a longitudinal axis extending therethrough in a horizontal direction;
a motor supported by the housing;
a battery pack removably coupled to a central portion of the housing;
a drive wheel assembly positioned within a deck portion of the housing and rotationally driven by the motor, the drive wheel assembly including a drive wheel and a driven wheel;
an opening defined within the deck portion of the housing and located between the drive wheel and the driven wheel, and below the central portion of the housing;
an endless saw blade driven by the drive wheel assembly and configured to pass through the opening to cut a workpiece during a cutting operation; and
a rear handle having a curvilinear shape with a first handle end coupled to the central portion of the housing and a second handle end adjacent the deck portion of the housing,
wherein the rear handle defines a curved path extending between a first end point at the first handle end and a second end point at the second handle end,
wherein a first tangent line tangent to the curved path at the first end point extends parallel to the longitudinal axis, and
wherein a second tangent line tangent to the curved path at the second end point extends perpendicular to the longitudinal axis.

2. The band saw of claim 1, wherein the curved path defines a first radius and a second radius, wherein the first radius is defined between the first end point and a center point of the curved path, and wherein the second radius is defined between the second end point and the center point of the curved path.

3. The band saw of claim 2, wherein the first radius is different than the second radius.

4. The band saw of claim 3, wherein the first radius is less than the second radius.

5. The band saw of claim 2, wherein the first radius is equal to the second radius.

6. The band saw of claim 1, wherein a first plane intersects with the first end point and a second plane intersects with the second end point, the first plane and the second plane are parallel to each other and extend perpendicular to the longitudinal axis, and wherein the motor is located between the first plane and the second plane.

7. The band saw of claim 1, further comprising a front handle coupled to the housing opposite the rear handle.

8. The band saw of claim 7, wherein the battery pack is disposed between the rear handle and the front handle.

9. A band saw comprising:
a housing defining a longitudinal axis extending therethrough in a horizontal direction;
a motor supported by the housing;
a battery pack removably coupled to a central portion of the housing;
a drive wheel assembly positioned within a deck portion of the housing and rotationally driven by the motor, the drive wheel assembly including a drive wheel and a driven wheel;
an opening defined within the deck portion of the housing and located between the drive wheel and the driven wheel;
an endless saw blade driven by the drive wheel assembly and configured to pass through the opening to cut a workpiece during a cutting operation;
a front handle coupled to the central portion of the housing; and
a rear handle having a curvilinear shape with a first handle end coupled to the central portion of the housing and a second handle end adjacent the deck portion of the housing, the rear handle defines a curved path extending between a first end point at the first handle end and a second end point at the second handle end,
wherein a first plane intersects the first end point and a second plane intersects the second end point,
wherein the first plane and the second plane are parallel to each other and extend perpendicular to the longitudinal axis,
wherein the motor is located between the first plane and the second plane, and
wherein the battery pack is located between the front handle and the first plane.

10. The band saw of claim 9, wherein the battery pack is coupled to the central portion along a battery insertion axis oriented at an insertion angle that is obliquely oriented relative to the longitudinal axis, and wherein the insertion angle ranges between 1 degree and 60 degrees.

11. The band saw of claim 10, wherein the insertion angle is 30 degrees.

12. The band saw of claim 10, wherein the insertion angle is 45 degrees.

13. The band saw of claim 9, wherein a center of gravity of the band saw is located between the rear handle and the front handle.

14. The band saw of claim 13, wherein the center of gravity of the band saw is located adjacent the opening.

15. The band saw of claim 9, wherein a first tangent line is tangent to the curved path at the first end point and a second tangent line is tangent to the curved path at the second end point.

16. The band saw of claim 15, wherein the first tangent line extends parallel to the longitudinal axis.

17. The band saw of claim 15, wherein the second tangent line extends perpendicular to the longitudinal axis.

18. The band saw of claim 9, wherein the opening is located below the central portion of the housing.

19. The band saw of claim 9, wherein the curved path defines a first radius and a second radius, wherein the first radius is defined between the first end point and a center point of the curved path, and wherein the second radius is defined between the second end point and the center point of the curved path.

20. The band saw of claim 19, wherein the first radius is different than the second radius.

21.-42. (canceled).
